(19) United States
(12) Patent Application Publication
(10) Pub. No.: US 2012/0038230 A1
(43) Pub. Date: Feb. 16, 2012

(54) ROTATING ELECTRIC MACHINE AND PRODUCTION METHOD FOR ROTATING ELECTRIC MACHINE

(76) Inventors: Yoshimi Kurahara, Ibaraki (JP); Koji Obata, Ibaraki (JP); Shuya Hagiwara, Ibaraki (JP); Kazumasa Ide, Ibaraki (JP)

(21) Appl. No.: 13/130,316

(22) PCT Filed: Nov. 20, 2009
(86) PCT No.: PCT/JP2009/069718

§ 371 Date: Nov. 2, 2011

(30) Foreign Application Priority Data
Nov. 21, 2008 (JP) 2008297608

(51) Int. Cl. H02K 3/28; H02K 15/06

(52) U.S. Cl. 310/71; 29/596

(57) ABSTRACT

A rotating electric machine includes: a stator in which a stator coil is mounted to a plurality of slots formed on a stator core; and a rotor that is rotatably disposed inside the stator. A slot groove, having a predetermined depth and a predetermined width from an end face of the stator core and forming a space between the stator coil and the stator core, is formed around each of the plurality of slots. The stator coil includes a straight-shaped straight section which is inserted into the slot and is provided with an insulating material, and a coil end section which extends outside of the slot and is bent at a same height as the end face of the stator core.

### TECHNICAL FIELD

The present invention relates to a rotating electric machine and a production method for the rotating electric machine.

### BACKGROUND ART

In a conventional stator for a rotating electric machine, an insulation paper is used to insulate between a stator core and a stator coil. In addition, a stator coil extending outside of a slot exit, i.e., so-called coil end, is provided with a straight section so as to reduce mechanical stress in the slot exit section and ensure a creepage distance and a spatial distance between the stator core and the stator coil.

The rotating electric machine is effectively reduced in size by reducing the coil end of the stator. However, bending the stator coil without providing the straight section of the coil end may result in mechanical stress or the like tearing the insulation paper insulating between the stator core and the stator coil, thereby causing insulation failure. Then, a method is proposed to reduce stress on the stator coil and the insulation paper at the slot exit section by forming a step section around the slot of the stator core and folding the insulation paper at this step section to form a dual structure (refer to patent literature 1 for example).
Patent literature 1: Japanese Laid Open Patent Publication No. H4-210744

### SUMMARY OF INVENTION

### Technical Problem

However, since in the conventional method as described above, the stator coil is bent from inside the slot, the creepage distance and the spatial distance between the stator coil and the end face of the stator core can not be sufficiently ensured. In addition, mechanical stress generated at the step section formed around the slot may result in reduction in the thickness of the insulation paper, thereby causing insulation failure.

### Solution to Problem

A rotating electric machine according to claim 1 is characterized by comprising: a stator in which a stator coil is mounted to a plurality of slots formed on a stator core; and a rotor that is rotatably disposed inside the stator, wherein: a slot groove, having a predetermined depth and a predetermined width from an end face of the stator core and forming a space between the stator coil and the stator core, is formed around each of the plurality of slots; and the stator coil includes a straight-shaped straight section which is inserted into the slot and is provided with an insulating material, and a coil end section which extends outside of the slot and is bent at a same height as the end face of the stator core.

A production method, according to claim 9, for a rotating electric machine including a stator in which a stator coil is mounted to a plurality of slots formed on a stator core and a rotor rotatably disposed inside the stator, is characterized by comprising: forming a slot groove, having a predetermined depth and a predetermined width from an end face of the stator core around each of the plurality of slots, that forms a space between the stator coil and the stator core; inserting the stator coil, having been provided with an insulating material, into the slot; inserting a coil bending jig into the slot groove to fix the stator coil; and bending the stator coil at a same height as the end face of the stator core with the coil bending jig as a fulcrum.

A production method, according to claim 10, for a rotating electric machine including a stator in which a stator coil is mounted to a plurality of slots formed on a stator core and a rotor rotatably disposed inside the stator, is characterized by comprising: forming a slot groove, having a predetermined depth and a predetermined width from an end face of the stator core around each of the plurality of slots, that forms a space between the stator coil and the stator core; inserting the stator coil that has been provided with an insulating material and bent in advance, into the slot; and a bent portion of the stator coil is arranged to be level with the end face of the stator core.

### Advantageous Effect of the Invention

According to the present invention, dielectric breakdown at an insulating material or the stator coil is prevented, the rotating electric machine is reduced in size, and the creepage distance and the spatial distance are ensured.

### BRIEF DESCRIPTION OF THE DRAWINGS

FIG. 1 A side sectional view of a rotating electric machine according to the first embodiment of the present invention.

FIG. 2 A sectional view of a stator of the rotating electric machine shown in FIG. 1.

FIG. 3 A sectional perspective view of a rotor of the rotating electric machine shown in FIG. 1.

FIG. 4 A perspective view showing a stator including a winding configuration with lap winding.

FIG. 5 An enlarged partial sectional view of the stator shown in FIG. 2.

FIG. 6 A partial sectional view of a slot formed in the stator core.

FIG. 7 A characteristic profile showing a relationship between the creepage distance and the spatial distance between the stator core and the stator coil, and the dielectric breakdown distance.

FIG. 8 A view of the stator core seen axially, illustrating a production method for the stator coil.

FIG. 9 An axial partial sectional view of the stator core, illustrating a production method for the stator coil.

FIG. 10 (a) to (c) Views illustrating a production method for the stator coil in the second embodiment of the present invention.

FIG. 11 A view showing a state in which the pre-bent stator coil is inserted into the slot.

FIG. 12 A view illustrating a production method for the stator according to the third embodiment of the present invention.

FIG. 13 A view illustrating a production method for the stator according to the fourth embodiment of the present invention.

FIG. 14 A view illustrating a production method for the stator according to the fifth embodiment of the present invention.

FIG. 15 A view illustrating a production method for the stator according to the sixth embodiment of the present invention.

### DESCRIPTION OF EMBODIMENTS

### First Embodiment

A rotating electric machine in the first embodiment of the present invention will now be explained in detail with reference to the drawings.

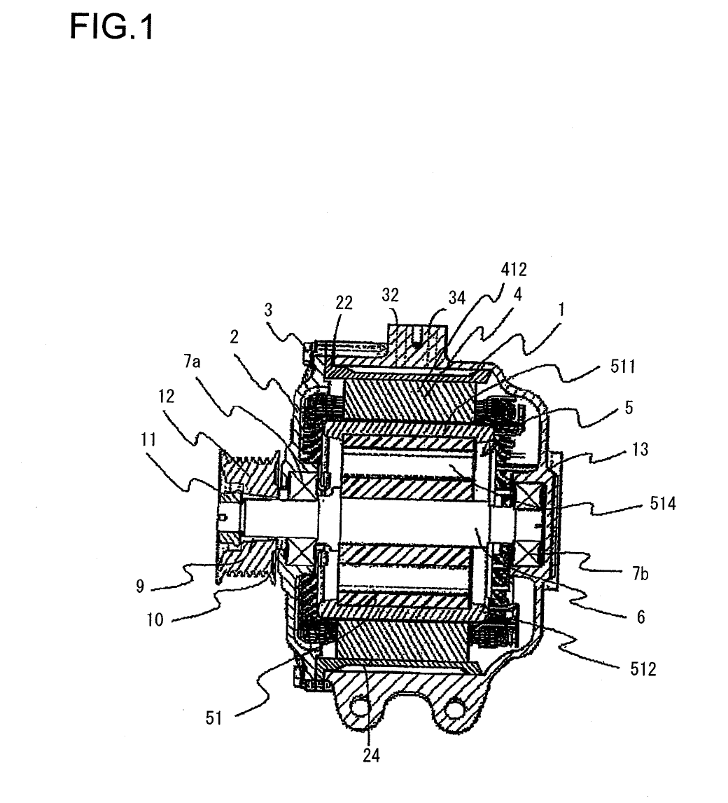

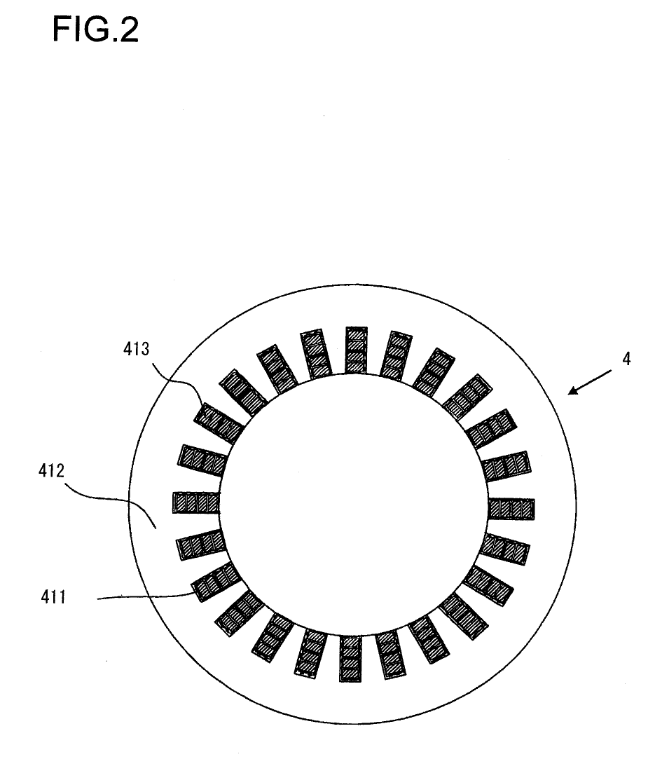

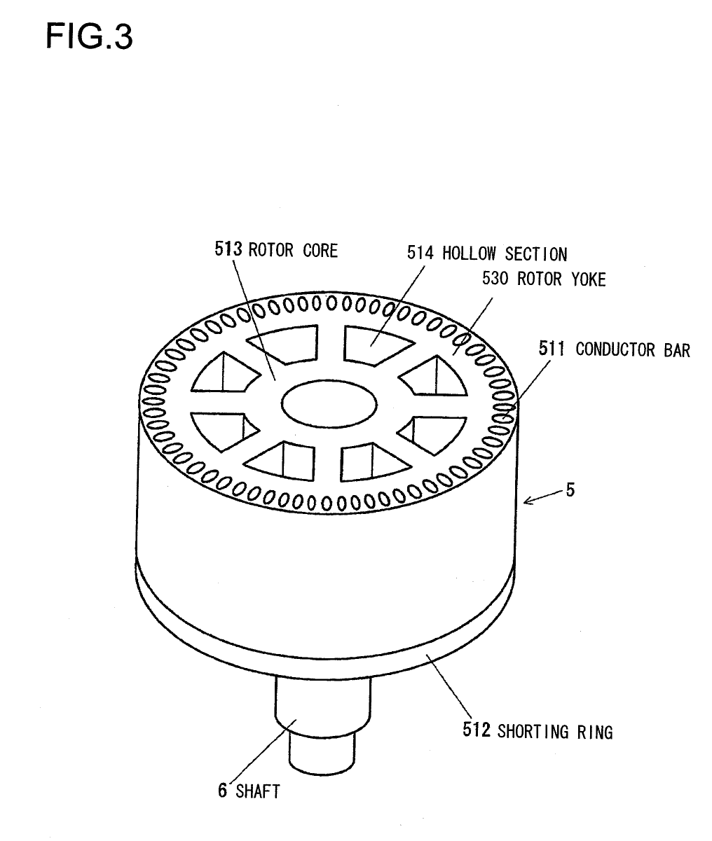

FIG. 1 is a side sectional view of an induction rotating electric machine in the first embodiment, FIG. 2 is a view showing a cross section of the stator, and FIG. 3 is a perspective view showing a cross section of the rotor. The induction rotating electric machine includes a bottomed cylindrical housing 1 having an opening at one axial end side and a cover 2 sealing the opening end of the housing 1. The housing 1 and the cover 2 are fastened with a plurality of, for instance, six bolts 3. The housing 1 is provided with a water path forming member 22 inside thereof, and a stator 4 is fixed to the inside of the water path forming member 22 by shrink fitting or the like. A flange of the water path forming member 22, shown on the left of the figure, is sandwiched between and fixed to the housing 1 and the cover 2, so that a water path 24 is formed between the water path forming member 22 and the housing 1. Coolant which cools the rotating electric machine is inlet to the water path 24 through an inlet 32 formed on the housing 1 and discharged from an outlet 34 of the housing 1.

The stator 4 is constituted with a stator core 412 in which a plurality of slots 411 are provided and spaced equally circumferentially and a three-phase stator coil 413 inserted into each of the slots 411. The stator core 412 in which the stator coil 413 is inserted has 24 slots 411 formed therein. The stator core 412 is formed with laminated steel plates prepared by punching or etching, for example, a magnetic steel plate of 0.05 to 0.35 mm thick and laminating the shaped magnetic steel plates, and the equally circumferentially spaced plurality of slots 411 are arranged radially in the stator core.

A rotor 5 is rotatably arranged in the inner circumference of the stator core 412 so as to oppose the stator core 412 through a tiny gap. The rotor 5 is fixed to a shaft 6 and rotates together with the shaft 6. The shaft 6 is rotatably supported by a pair of ball bearings 7a and 7b provided on the housing 1 and the cover 2, respectively. Of those bearings 7a and 7b, the bearing 7a, on the cover 2 side, is fixed to the cover 2 with a fixing plate not shown in the figures and the bearing 7b, on the bottom side of the housing 1, is fixed to a recess provided on the bottom of the housing 1.

A pulley 12 is attached to the left end of the shaft 6 with a nut 11. A sleeve 9 and a spacer 10 are provided at the shaft 6 between the pulley 12 and the bearing 7a. The outer circumference of the sleeve 9 and the inner circumference of the pulley 12 have a slightly conical shape. The pulley 12 and the shaft 6 are firmly integrated on tightening force by the nut 11, so that those can rotate together. When the rotor 5 is rotationally driven relative to the stator 4, rotational force of the shaft 6 is output externally through the pulley 12. In addition, when working as an electric generator, rotational force from the pulley 12 is input into the shaft 6.

As shown in FIG. 3, a rotor core 513 of the rotor 5, which is a squirrel-cage rotor, is embedded with a plurality of conductor bars 511 extending in the rotation axis over the whole circumference at regular intervals. The rotor core 513 is made of a magnetic material, and each of the axial ends of the rotor core 513 is provided with a shorting ring 512 shorting each of the conductor bars 511. It is to be noted that the perspective view of FIG. 3 shows the cross-sectional structure of a cross-sectional surface perpendicular to the rotation axis so as to manifest the relationship between the rotor core 513 and the conductor bars 511, and thus the shorting ring 512 and the shaft 6 on the pulley 12 side are not illustrated.

The rotor core 513 is constituted with laminated steel plates prepared by punching or etching a magnetic steel plate of 0.05 to 0.35 mm thick and laminating the shaped magnetic steel plates. As shown in FIG. 3, substantially fan-shaped hollow sections 514 are provided and spaced equally circumferentially in the inner circumference side of the rotor core 513 for weight reduction. The conductor bars 511, described above, are embedded in the outer circumference side of the rotor core 513, i.e., in the stator side, and a magnetic circuit is formed on a rotor yoke 530 inward of the conductor bars 511. Each of the conductor bars 511 and the shorting ring 512 are made of aluminium and integrated with the rotor core 513 by die casting. The shorting ring 512 disposed at the both ends of the rotor core is arranged to protrude from the rotor core 513 to the axial ends. It is to be noted that although not illustrated in FIG. 1, the bottom side of the housing 1 is provided with a detecting rotor for detecting rotation of the rotor 5. A rotation sensor 13 detects teeth of the rotating detecting rotor and outputs an electrical signal for detecting the position of the rotor 5 and the rotational speed of the rotor 5.

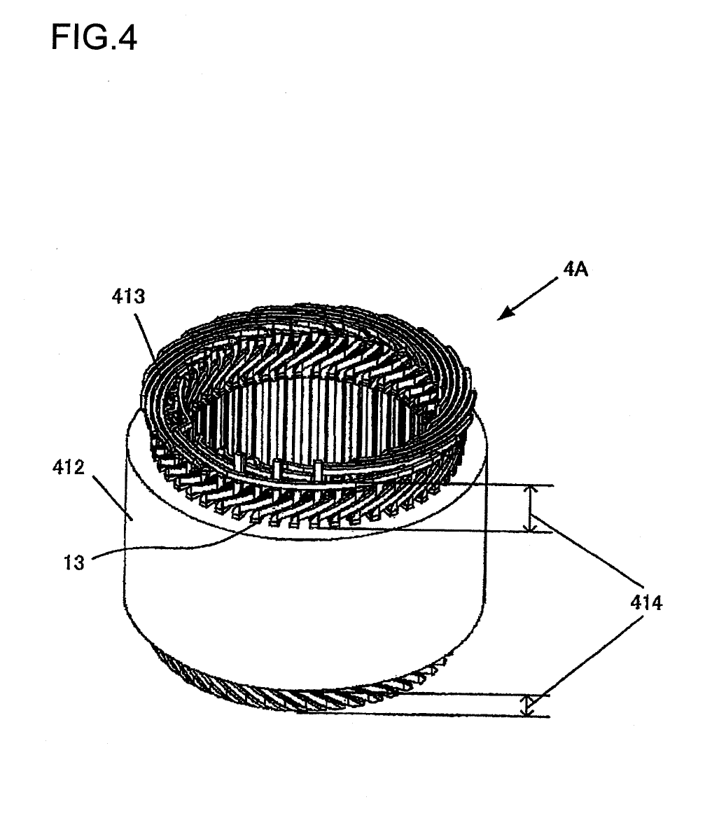

As a comparison example of the stator 4 according to the first embodiment, FIG. 4 shows a perspective view of a stator 4A which includes 48 slots and in which the stator coil 413 is wound in each of the slots by lap winding. The stator coil 413 is wound around a pair of slots across a predetermined number of slots therebetween. A coil end 414 is formed on each end face of the stator core 412 by the stator coil 413 protruding outwardly from each of the slots.

As shown in FIG. 4, a straight section where the stator coil 413 extends straight is provided at the coil end 414 in the vicinity of the exit section of each of the slots, and an insulation paper 13 is wound around it so as to ensure a creepage distance and a spatial distance between the stator core 412 and the stator coil 413. In order to reduce the stator 4A in size while maintaining the output of the rotating electric machine, the coil end 414 is required to be reduced in the rotation axis direction of the rotating electric machine. However, bending the stator coil 413 without providing a straight section for reducing the coil end 414 may cause the insulation paper 13 wound around the stator coil 413 or enamel coating to be broken due to an effect of electrical stress or mechanical stress at the exit section of each of the slots. Otherwise, there is a problem that the bending of the stator coil 413 causes the insulation paper 13 to be opened and the stator coil 413 and the stator core 412 to come into contact with each other, thereby causing insulation failure.

Then, in the first embodiment, the stator 4 is configured so as to reduce the coil end 414 while preventing electrical breakdown in the insulation paper 13 or enamel coating caused by mechanical stress generated in the stator coil 413 at the exit section of each of the slots and securing the creepage distance and the spatial distance between the stator coil 413 and the stator core 412.

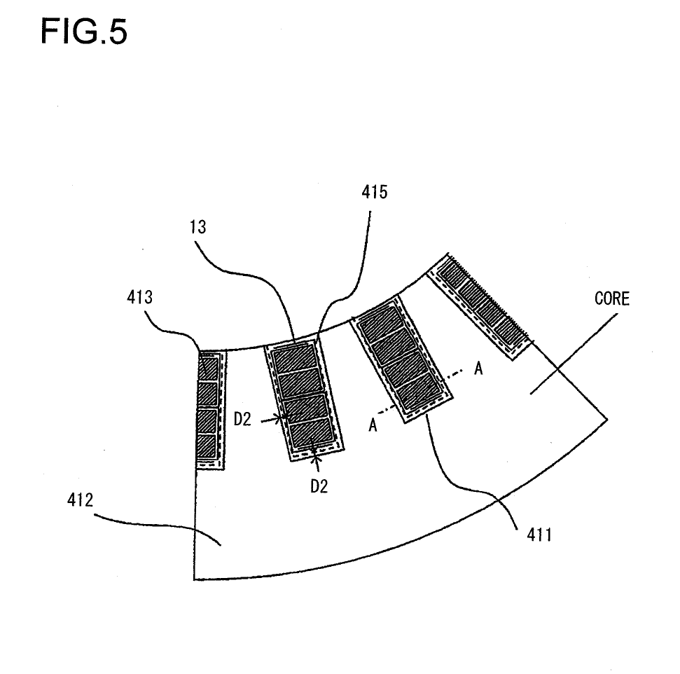

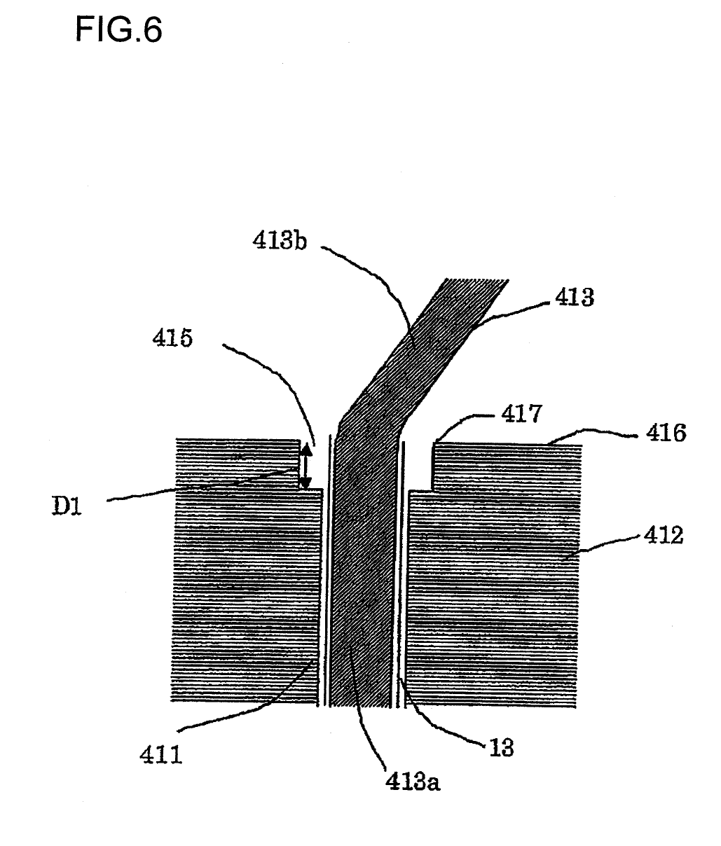

The configuration of the stator 4 in the first embodiment will now be explained in detail. FIG. 5 shows an enlarged partial sectional view of the stator 4 shown in FIG. 2. FIG. 6 shows an A-A sectional view of the slot 411 shown in FIG. 5. As shown in FIG. 5 and FIG. 6, a slot groove 415 is provided around each of the slots 411 of the stator core 412. The slot groove 415 is provided surrounding the slot 411 so as to form a space between the stator coil 413 and the exit section of the slot 411. The slot groove 415 can be formed by preparing the stator core 412 by, for instance, laminating magnetic steel plates which have been punched and shaped corresponding to the position and the size of the slot groove 415.

An axial depth D1 and radial and circumferential widths D2 from a core end face 416 of the slot groove 415 are each appropriately set based upon electrical breakdown voltage at the rotating electric machine so as to sufficiently ensure the creepage distance and the spatial distance between the stator core 412 and the stator coil 413. It is to be noted that the dashed line in FIG. 5 denotes an inside end of the slot groove 415.

As shown in FIG. 6, the stator coil 413 is not provided with a straight section at the coil end 414 described above and is bent at a slot exit section 417, i.e., at the height of the core end face 416 of the stator core 412. In addition, the insulation paper 13 insulating between the stator core 412 and the stator coil 413 is provided inside the slot 411, at least up to the core end face 416. In other words, the stator coil 413 is constituted with a straight section 413a inserted into the slot 411 and covered with the insulation paper 13 and a coil end section 413b extending outside of the slot 411, bent, and not covered with the insulation paper 13. It is to be noted that the coil end 414 described above is formed by the coil end section 413b of the stator coil 413.

Here, the spatial distance is a minimum distance in the space between the stator core 412 and the stator coil 413, which corresponds to the minimum distance from the slot exit section 417 of the stator core 412 to the coil end section 413b of the stator coil 413 in FIG. 6. The creepage distance is a minimum distance along the insulation paper 13 between the stator core 412 and the stator coil 413, which corresponds to the axial depth D1 of the slot groove 415 in FIG. 6.

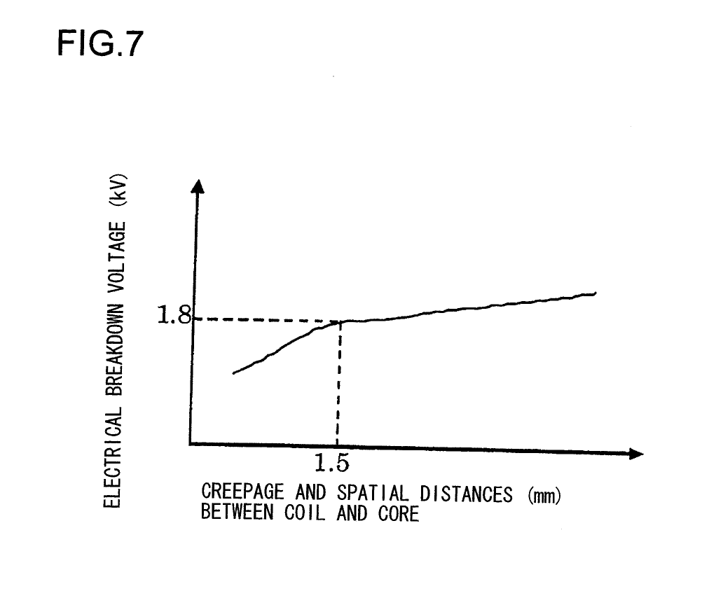

FIG. 7 shows a characteristic profile showing a relationship between the creepage distance and the spatial distance between the stator core 412 and the stator coil 413 and electrical breakdown voltage at the rotating electric machine. IEC60034 (standard for general information on motors) issued by IEC (International Electrotechnical Commission) specifies that a dielectric strength test for a motor exceeding 150 V is to be conducted with the test voltage at least 1500 V for one minute. It is to be noted that voltage 1.2 times higher than that of the standard is accepted if a one-minute voltage withstand test is substituted with a one-second voltage withstand test in a mass production line or the like. Thus, if the rotating electric machine according to the first embodiment is a low voltage rotating electric machine of between 150 V and 600 V, this rotating electric machine is required to withstand the voltage withstand test of 1.5 kV×1.2=1.8 kV.

As shown in FIG. 7, the creepage distance or the spatial distance corresponding to 1.8 kV, which is a short-time electrical breakdown voltage, is 1.5 mm. Accordingly, the stator 4 is required to be configured with the creepage distance and the spatial distance between the stator core 412 and the stator coil 413 each ensured to be at least 1.5 mm. Then, in the first embodiment, if the rotating electric machine is a low voltage rotating electric machine of equal to or less than 600 V, the axial depth D1 of the slot groove 415 is set to 1.5 mm or greater and the radial and circumferential widths D2 is set to 1.5 mm or greater. It is to be noted that the axial depth D1 and the radial and circumferential widths D2 of the slot groove is preferably set to as minimum as possible so as not to reduce the output of the rotating electric machine.

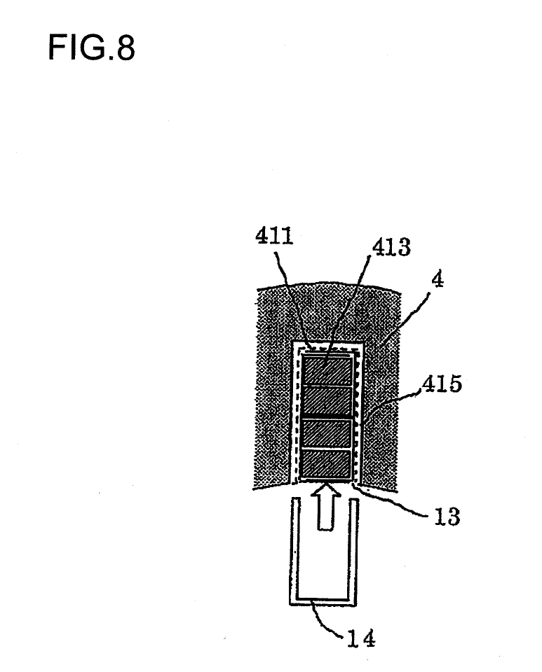

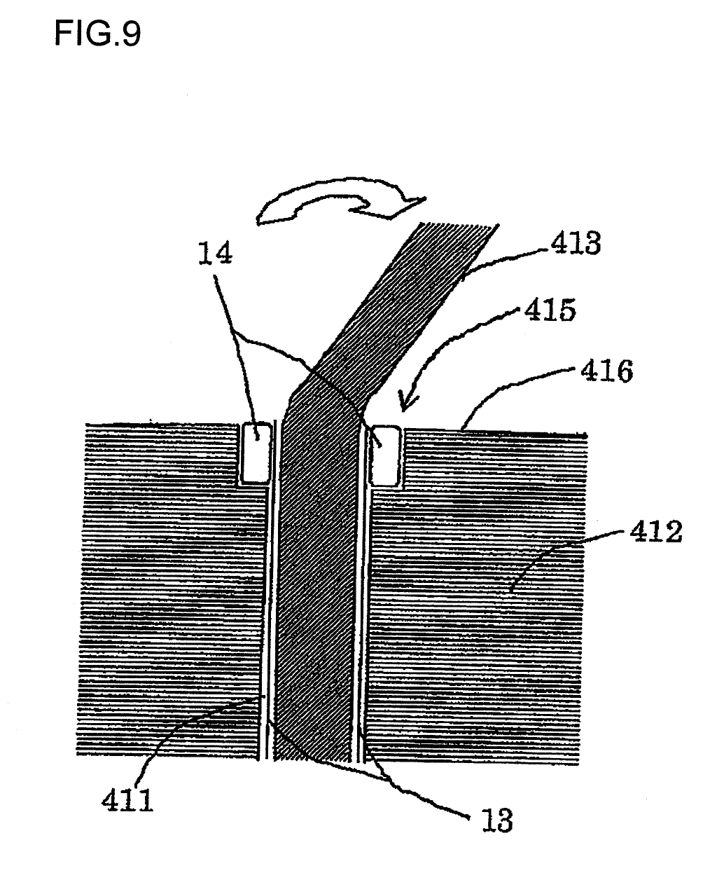

Next, a production method for the rotating electric machine according to the first embodiment will be explained. The rotor 5 and the stator core 412 can be produced by adopting a known method. A production method for the stator coil 413 will be mainly explained now. FIG. 8 shows a view in which one slot 411 of the stator core 412 is viewed axially, and FIG. 9 shows an axial sectional view of the slot 411 of the stator core 412.

At first, if the stator coil 413 has a winding configuration in a wave winding method, a straight conductor (the stator coil 413) around which the insulation paper 13 is wound is insert axially into the slot 411 of the stator core 412. Here, a rectangular wire is used as the conductor. Next, as shown in FIG. 8, a U-shaped coil bending jig 14 is inserted into the slot groove 415. The axial height of the coil bending jig 14 is substantially the same as the axial depth D1 of the slot groove 415 as shown in FIG. 9. In a state in which the conductor is fixed with the coil bending jig 14, the conductor is bent at a desired angle with the coil bending jig 14 inserted into the slot groove 415 as a fulcrum. Then, the coil bending jig 14 is removed from the slot groove 415. This can realize the stator coil 413 which is bent at the same height as the core end face 416 as shown in FIG. 6, i.e., has a bent portion at the same height as the core end face 416. The stator coil 413 is not bent at the straight section 413a inserted into the slot 411 and it is bent from the core end face 416. The coil end section 413b of the stator coil 413 corresponds to a portion which extends outside from the slot 411 and is bent from the core end face 416 without a straight section.

The coil bending jig 14 has a sufficient strength to bend the stator coil 413 and is made of an appropriate material that does not cause damage to the stator coil 413. It is to be noted that if the coil bending jig 14 is an insulator, the coil bending jig 14 may remain in the slot groove 415. If the stator coil 413 has a winding configuration in a distributed winding method, the conductor is inserted into the slot 411 from the inner diameter side of the stator core 412.

The following operations and advantageous effects can be achieved in the first embodiment explained above.

(1) The rotating electric machine includes the stator 4 in which the stator coil 413 is inserted into the plurality of slots 411 formed on the stator core 412 and the rotor 5 rotatably provided inside the stator 4. Around each of the plurality of slots 411, the slot groove 415, having a predetermined depth and a predetermined width from the end face 416 of the stator core 412 and forming a space between the stator coil 413 and the stator core 412, is formed. The stator coil 413 includes the straight section 413a, having a straight shape and being inserted into the slot 411 and provided with an insulating material (the insulation paper 13), and the coil end section 413b, extending outside of the slot 411 and being bent at the same height as the end face 416 of the stator core 412. This prevents electrical breakdown of enamel coating of the insulation paper 13 and the stator coil 413 and allows the coil end 414 to be reduced axially while ensuring the creepage distance and the spatial distance, thereby enabling the entire rotating electric machine to be reduced in size.
(2) The slot groove 415 has the predetermined depth D1 in the rotation axis direction of the rotating electric machine and the predetermined width D2 in the circumferential and radial directions of the stator core 412, and the predetermined depth D1 and the predetermined width D2 are each set based upon electrical breakdown voltage of the rotating electric machine. More specifically, if the rotating electric machine is a low voltage rotating electric machine of equal to or less than 600 V, the depth and the width of the slot groove 415 is each equal to or greater than 1.5 mm. This allows the slot groove 415 to have an appropriate size in view of electrical breakdown voltage of the rotating electric machine and can effectively prevent electrical breakdown and insulation failure of the insulation paper 13 and the like.
(3) The insulating material (the insulation paper 13) is provided on the stator coil 413 in the slot 411 at least up to the height of the end face 416 of the stator core 412. Since the insulation paper 13 does not protrude outside the slot 411, the bending of the stator coil 413 can prevent the insulation paper 13 from becoming thin or broken.
(4) When producing the stator 4 to be included in the rotating electric machine, at first the slot groove 415, having the predetermined depth D1 and the predetermined width D2 from the end face 416 of the stator core 412 and forming a space between the stator coil 413 and the stator core 412, is formed around each of the plurality of slots 411. Then, the stator coil 413 provided with the insulation paper 13 is inserted into the slot 411 and the coil bending jig 14 is inserted into the slot groove 415 so as to fix the stator coil 413, and the stator coil 413 is bent at the same height as the end face 416 of the stator core 412 with the coil bending jig 14 as a fulcrum.

### Second Embodiment

The rotating electric machine according to the second embodiment of the present invention will now be explained. The overall structure of the rotating electric machine in the second embodiment is the same as that of the first embodiment described above. The following explanation will mainly focus upon the difference from the first embodiment.

In the production method for the stator coil 413 in the first embodiment described above, the conductor which constitutes the stator coil 413 is inserted into the slot 411 before the conductor is bent at a predetermined angle so as to form the stator coil 413. However, if the slot 411 of the stator core 412 is a so-called open slot as shown in FIG. 2, a conductor bent in advance at a predetermined angle may be inserted into the slot 411 so as to form the stator coil 413. The production method for the stator coil 413 according to the second embodiment will now be explained in detail.

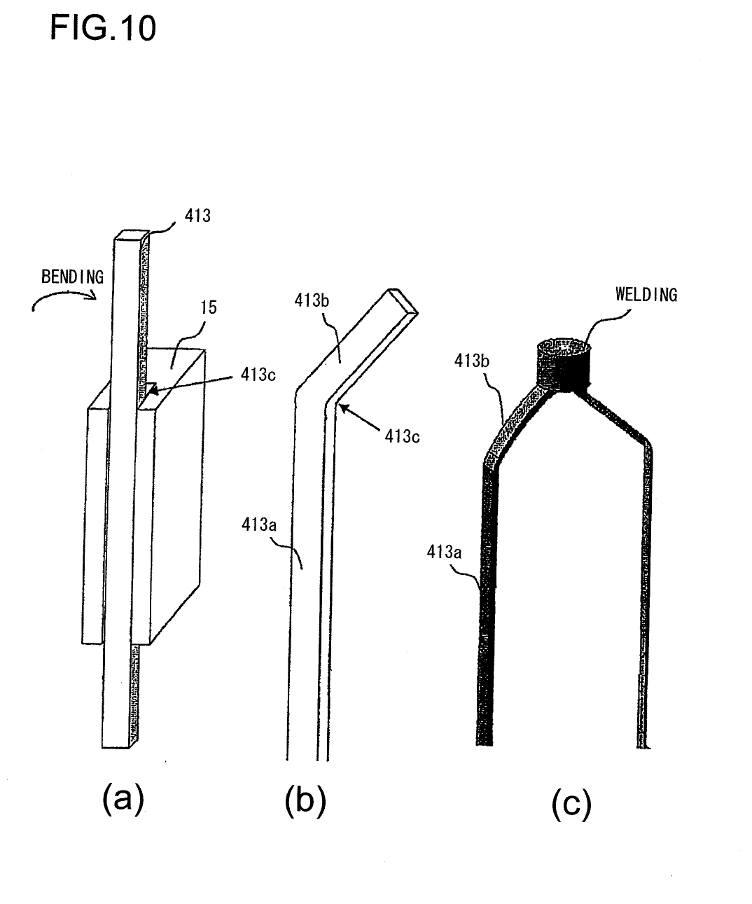

At first, as shown in FIG. 10(a), a rectangular wire conductor constituting the stator coil 413 is inserted into and fixed to a metal coil bending jig 15. At this time, the coil bending jig 15 and the conductor are fixed so that a bent portion 413c of the stator coil 413, i.e., a boundary between the straight section 413a and the coil end section 413b of the stator coil 413, is level with the upper end of the coil bending jig 15. In a state in which the conductor is fixed to the coil bending jig 15, the conductor is bent at a desired angle and the coil bending jig 15 is then removed. This allows the stator coil 413 having the bent portion 413c to be formed as shown in FIG. 10(b). It is to be noted that the insulation paper 13 may be wound around the straight section 413a of the stator coil 413 before bending the stator coil 413 or may be wound around the straight section 413a after bending the stator coil 413.

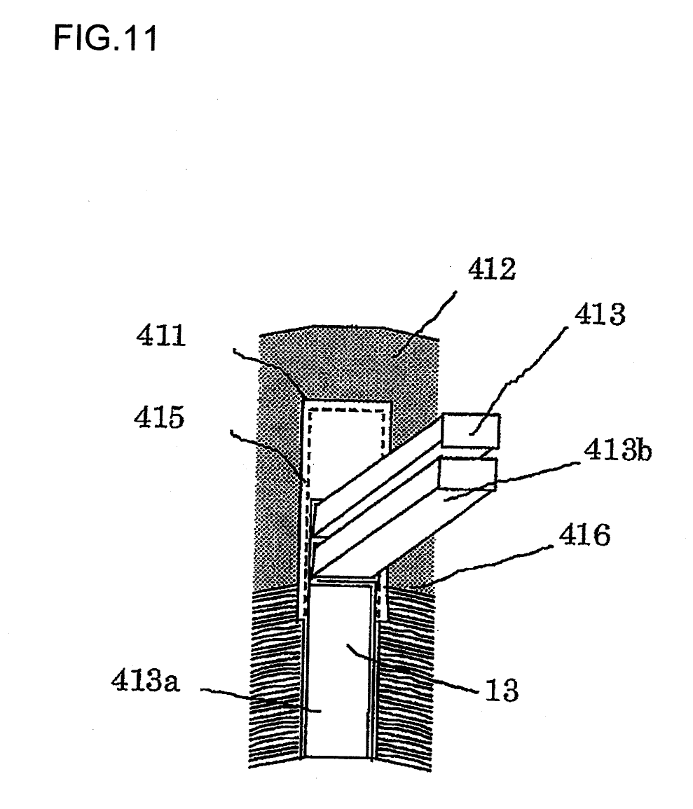

The stator coil 413 bent as shown in FIG. 10(b) is inserted into the slot 411 from the inner diameter side of the stator core 412. The bent portion 413c of the stator coil 413 is arranged to be level with the core end face 416 of the stator core 412. FIG. 11 shows a partial perspective view of a state in which two pre-bent stator coils 413 are inserted into the slot 411, viewed from the inner diameter side of the stator core 412. As shown in FIG. 11, in the stator coil 413, the straight section 413a around which the insulation paper 13 is wound is inserted into the slot 411 and the coil end section 413b without the insulation paper 13 is bent at the same height as the core end face 416 of the stator core 412.

The stator coil 413 inserted into the slot 411 as shown in FIG. 11 is connected with the stator coil 413 inserted into another slot 411 corresponding thereto (refer to FIG. 10(c)). The stator coils 413 are connected with each other by a method, for instance, TIG welding, fusing, fusing brazing, resistance brazing, or the like.

As explained above, also in the second embodiment, similarly to the first embodiment described above, the coil end 414 can be reduced axially while preventing electrical breakdown of enamel coating of the insulation paper 13 and the stator coil 413 and ensuring the creepage distance and the spatial distance. This allows the entire rotating electric machine to be reduced in size.

When producing the stator 4 to be included in the rotating electric machine, at first, the slot groove 415, having the predetermined depth D1 and the predetermined width D2 from the end face 416 of the stator core 412 and forming a space between the stator coil 413 and the stator core 412, is formed around each of the plurality of slots 411. Then, the pre-bent stator coil 413 on which the insulation paper 13 is provided is inserted into the slot 411 and the bent portion 413c of the stator coil 413 is arranged to be level with the end face 416 of the stator core 412.

### Third Embodiment

The rotating electric machine according to the third embodiment of the present invention will now be explained. The overall structure of the rotating electric machine in the third embodiment is the same as that of the first embodiment described above. The following explanation will mainly focus upon the difference from the first embodiment.

As described earlier, in a low voltage rotating electric machine of, for example, equal to or less than 600 V, it is necessary to ensure each of the creepage distance and the spatial distance between the stator core 412 and the stator coil 413 to be at least 1.5 mm. However, it may be difficult to ensure each of the creepage distance and the spatial distance to be at least 1.5 mm in a small rotating electric machine for instance. Then, in the third embodiment, even if it is difficult to form the slot groove 415 with the depth and the width of at least 1.5 mm, insulation failure due to insufficient creepage distance and spatial distance can be prevented.

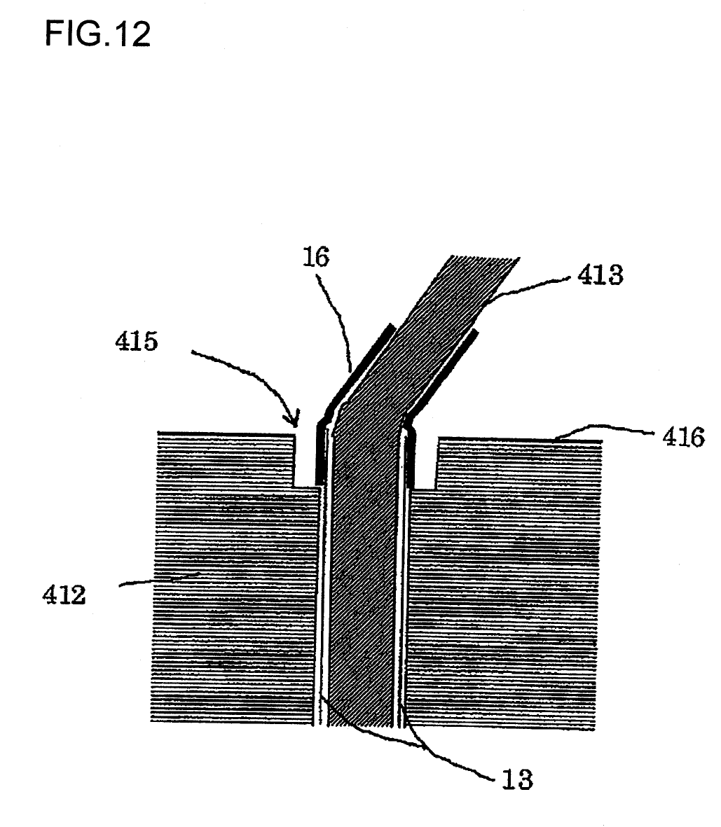

More specifically, as shown in FIG. 12, an insulation tape 16 is wound around from a portion inside the slot groove 415 of the stator coil 413 to a portion outside the slot 411. The insulation tape 16 is a thin insulator for insulating between the stator core 412 and the stator coil 413. As shown in FIG. 12, the insulation tape 16 is attached inside the slot groove 415 so as to cover the insulation paper 13.

For winding the insulation tape 16 around the stator coil 413, the axial depth D1 and the radial and circumferential widths D2 of the slot groove 415 may have at least an enough size for the insulation tape 16 to be wound around the stator coil 413. The stator coil 413 may be bent before inserted into the slot 411 or may be bent after inserted into the slot 411.

As explained above, also in the third embodiment, similarly to the first and the second embodiments described above, the coil end 414 can be reduced axially while preventing electrical breakdown of the insulation paper 13 and enamel coating of the stator coil 413 and ensuring the creepage distance and the spatial distance. This allows the entire rotating electric machine to be reduced in size. In addition, even if the creepage distance and the spatial distance required based upon electrical breakdown voltage at the rotating electric machine can not be ensured by the slot groove 415, the insulation tape 16 is provided on the stator coil 413 so as to prevent well electrical breakdown of the insulation paper 13 and the enamel coating and to prevent insulation failure of the stator core 412 and the stator coil 413.

### Fourth Embodiment

The rotating electric machine according to the fourth embodiment of the present invention will now be explained. The overall structure of the rotating electric machine in the fourth embodiment is the same as that of the first embodiment described above. The following explanation will mainly focus upon the difference from the first to the third embodiments.

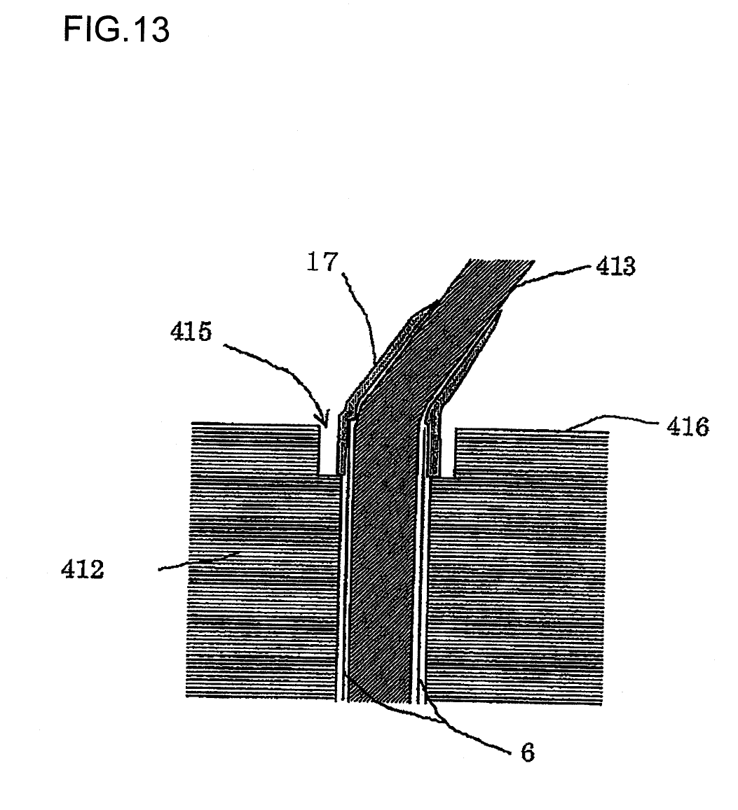

The stator coil 413 may be provided with an insulation powder resin coat 17 as shown in FIG. 13 if, for instance, the stator coils 413 provided on the stator core 412 are narrowly spaced with each other and it is thus difficult to wind the insulation tape 16 used in the third embodiment described above around the stator coil 413. The insulation powder resin coat 17 is applied from a portion inside the slot groove 415 of the stator coil 413 to a portion outside the slot 411. The stator coil 413 may be bent before inserted into the slot 411 or may be bent after inserted into the slot 411.

Thus, a similar effect to that of the third embodiment can be achieved by forming an insulation layer on the stator coil 413 by the insulation powder resin coat 17.

### Fifth Embodiment

The rotating electric machine according to the fifth embodiment of the present invention will now be explained. The overall structure of the rotating electric machine in the fifth embodiment is the same as that of the first embodiment described above. The following explanation will mainly focus upon the difference from the first to the fourth embodiments.

In the fifth embodiment, an insulation layer is formed on the core end face 416 of the stator core 412. This allows electrical breakdown and insulation failure of the insulation paper 13 to be prevented well even if, for instance, it is difficult to ensure the creepage distance and the spatial distance by the slot groove 415 as explained in the first and the second embodiments and it is difficult to form an insulation layer on the stator coil 413 as explained in the third and the fourth embodiment.

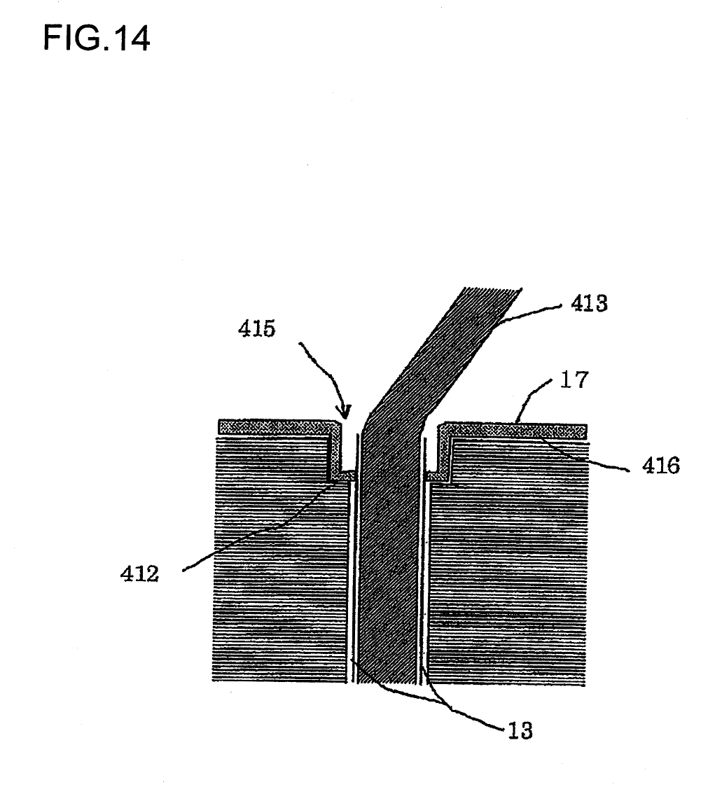

More specifically, as shown in FIG. 14, in the stator core 412, the insulation powder resin coat 17 is applied from the inside of the slot groove 415 to the core end face 416. The insulation powder resin coat 17 may be applied to a range from inside the slot groove 415 to around the slot 411, which may secure sufficient creepage distance and the spatial distance between the stator core 412 and the stator coil 413.

In addition, for applying the insulation powder resin coat 17 onto the stator core 412, the axial depth D1 and the radial and circumferential widths D2 of the slot groove 415 may have an enough size to apply the insulation powder resin coat 17 at least. The stator coil 413 may be bent before inserted into the slot 411 or may be bent after inserted into the slot 411.

As explained above, also in the fifth embodiment, similarly to the first to the fourth embodiments described above, electrical breakdown of the insulation paper 13 and the enamel coating and insulation failure of the stator core 412 with the stator coil 413 can be prevented well.

### Sixth Embodiment

The rotating electric machine according to the sixth embodiment of the present invention will now be explained. The overall structure of the rotating electric machine in the sixth embodiment is the same as that of the first embodiment described above. The following explanation will mainly focus upon the difference from the first to the fifth embodiments.

The slot exit section 417 of the stator core 412 may be chamfered if, for example, it is difficult to ensure the creepage distance and the spatial distance by the slot groove 415 as explained in the first and the second embodiments.

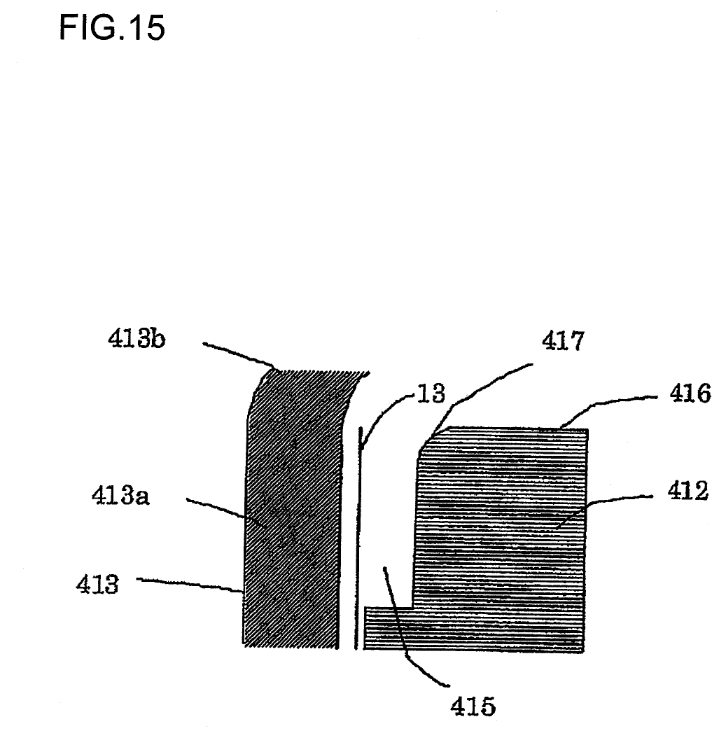

FIG. 15 shows an enlarged partial sectional view of the vicinity of the slot exit section 417. More specifically, as shown in FIG. 15, the slot exit section 417 at which the slot groove 415 and the core end face 416 are to cross or meet is chamfered with a curved surface. This can ensure the spatial distance between the stator core 412 and the coil end section 413b of the stator coil 413.

It is to be noted that although FIG. 15 merely shows a part of the slot groove 415, a chamfer is provided all around the slot groove 415. The chamfer is not limited to that with a curved surface as shown in FIG. 15, and it may be planar or polyhedron. The stator coil 413 may be bent before inserted into the slot 411 or may be bent after inserted into the slot 411.

As explained above, also in the sixth embodiment, similarly to the first to the fifth embodiments described above, electrical breakdown of the insulation paper 13 and the enamel coating and insulation failure of the stator core 412 with the stator coil 413 can be prevented well.

While in the first to the sixth embodiments explained above, the insulation paper 13 is used to insulate between the stator coil 413 and the stator core 412, the present invention is not limited thereto and an insulating material other than the insulation paper may be used to insulate between the stator coil 413 and the stator core 412. In other words, it is acceptable as long as the straight section 413a of the stator coil 413 inserted into the slot 411 is covered with an insulating material.

It is to be noted that the rotating electric machine in the first to the sixth embodiments can be modified as follows.

(1) While in the first to the sixth embodiments, an induction rotating electric machine is explained as an example, the present invention can be applied also to a stator coil of, for instance, a permanent magnet type rotating electric machine or the like.
(2) The conductor used for the stator coil 413 is not limited to have a rectangular cross-section, and the present invention can be applied to that using a circular round wire.
(3) The winding method of the stator coil 413 may be a distributed winding or a wave winding.
(4) The stator core 412 may assume a structure other than that of a laminated core.

It is to be noted that the present invention may be embodied in any way other than those described in reference to the embodiments, as long as the features characterizing the present invention remain intact.

The disclosure of the following priority application is herein incorporated by reference: Japanese Patent Application No. 2008-297608 (filed on Nov. 21, 2008).

1. A rotating electric machine, comprising:
a stator in which a stator coil is mounted to a plurality of slots formed on a stator core; and
a rotor that is rotatably disposed inside the stator, wherein:
a slot groove, having a predetermined depth and a predetermined width from an end face of the stator core and forming a space between the stator coil and the stator core, is formed around each of the plurality of slots; and
the stator coil includes a straight-shaped straight section which is inserted into the slot and is provided with an insulating material, and a coil end section which extends outside of the slot and is bent at a same height as the end face of the stator core.

2. A rotating electric machine according to claim 1, wherein:
the slot groove includes the predetermined depth in a rotation axis direction of the rotating electric machine and the predetermined width in a circumferential and a radial directions of the stator core, and the predetermined depth and the predetermined width are each set based upon electrical breakdown voltage of the rotating electric machine.

3. A rotating electric machine according to claim 2, wherein:
the rotating electric machine is a low voltage rotating electric machine of equal to or less than 600 V; and
the predetermined depth of the slot groove is equal to or greater than 1.5 mm.

4. A rotating electric machine according to claim 2, wherein:
the rotating electric machine is a low voltage rotating electric machine of equal to or less than 600 V; and
the predetermined width of the slot groove is equal to or greater than 1.5 mm.

5. A rotating electric machine according to claim 1, wherein:
the insulating material is provided on the stator coil in the slot at least up to a height of the end face of the stator core.

6. A rotating electric machine according to claim 1, wherein:
the stator coil is provided with an insulator from the straight section inside the slot groove to the coil end section outside the slot groove.

7. A rotating electric machine according to claim 1, wherein:
the stator core is provided with an insulator from inside the slot groove to the end face.

8. A rotating electric machine according to claim 1, wherein:
the slot groove is chamfered at a section at which the slot groove is to meet the end face of the stator core.

9. A production method for a rotating electric machine including a stator in which a stator coil is mounted to a plurality of slots formed on a stator core and a rotor rotatably disposed inside the stator, comprising:
forming a slot groove, having a predetermined depth and a predetermined width from an end face of the stator core around each of the plurality of slots, that forms a space between the stator coil and the stator core;
inserting the stator coil, having been provided with an insulating material, into the slot;
inserting a coil bending jig into the slot groove to fix the stator coil; and
bending the stator coil at a same height as the end face of the stator core with the coil bending jig as a fulcrum.

10. A production method for a rotating electric machine including a stator in which a stator coil is mounted to a plurality of slots formed on a stator core and a rotor rotatably disposed inside the stator, comprising:
forming a slot groove, having a predetermined depth and a predetermined width from an end face of the stator core around each of the plurality of slots, that forms a space between the stator coil and the stator core;
inserting the stator coil that has been provided with an insulating material and bent in advance, into the slot; and
a bent portion of the stator coil is arranged to be level with the end face of the stator core.
